(19) United States
(12) Patent Application Publication
(10) Pub. No.: US 2014/0354551 A1
(43) Pub. Date: Dec. 4, 2014

(54) KEYBOARD ASSEMBLY

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: XIAO-YONG MA, Shenzhen (CN)

(73) Assignees: HONG FU JIN PRECISION INDUSTRY (ShenZhen) CO., LTD, Shenzhen (CN); HON HAI PRECISION INDUSTRY CO., LTD., New Taipei (TW)

(21) Appl. No.: 14/139,972

(22) Filed: Dec. 24, 2013

(30) Foreign Application Priority Data
May 31, 2013 (CN) 2013102123800

(51) Int. Cl. G06F 3/02

(52) U.S. Cl. CPC G06F 3/021
USPC 345/168

(57) ABSTRACT

A keyboard assembly includes a main body, a handwriting pad, and a fixing member. The main body defines a receiving space. The handwriting pad is rotatably received in the receiving space and includes a frame body and a protrusion located on the frame body. The handwriting pad is rotatable and secured to the main body by the fixing member. In addition, the handwriting pad is rotatable about the fixing member to remove the handwriting pad from the receiving space.

### BACKGROUND

1. Technical Field

The present disclosure relates to peripheral components, and particularly to an keyboard assembly.

2. Description of Related Art

With the popularity of computers, consumers not only require computers with efficiency but are also paying more attention to the functions and designs of computer accessories such as keyboards. Usually, the keyboards are just for inputting words into the computer by manual manipulation of keys, that is inconvenience for users. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a keyboard assembly.

FIG. 2 is an enlarge view of a circled portion II of FIG. 1.

FIG. 3 is similar to FIG. 1, but viewed from a different aspect.

FIG. 4 is an exploded, isometric view of an embodiment of a handwriting pad of the keyboard assembly.

FIG. 5 is an enlarge view of a circled portion IV of FIG. 3.

FIG. 6 is an assembled view of the keyboard assembly of FIG. 1, and the handwriting pad is received in a receiving space.

FIG. 7 is similar to FIG. 6, and the handwriting pad is rotatable out of the receiving space.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

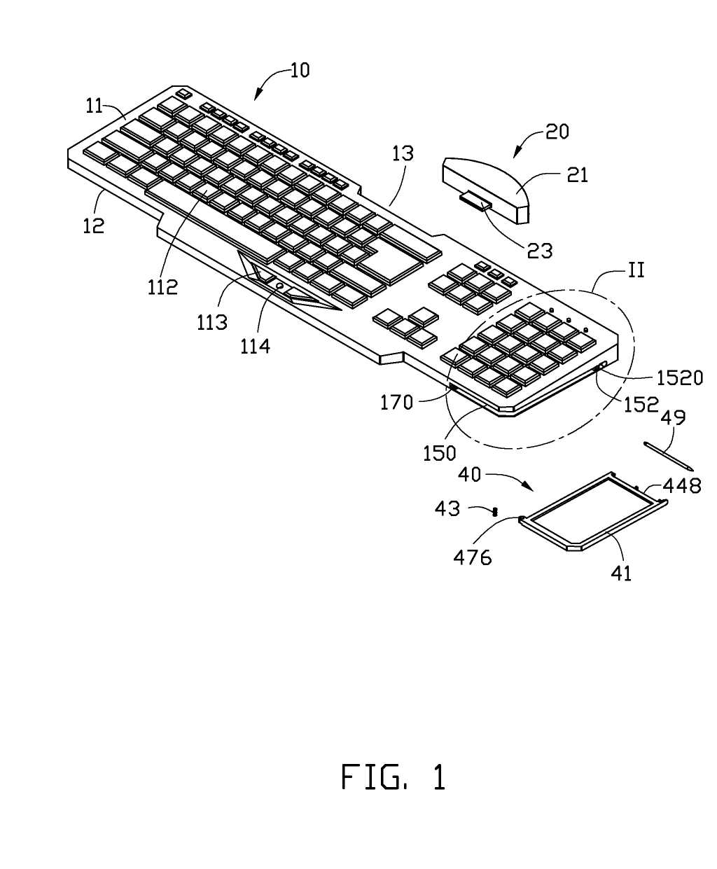

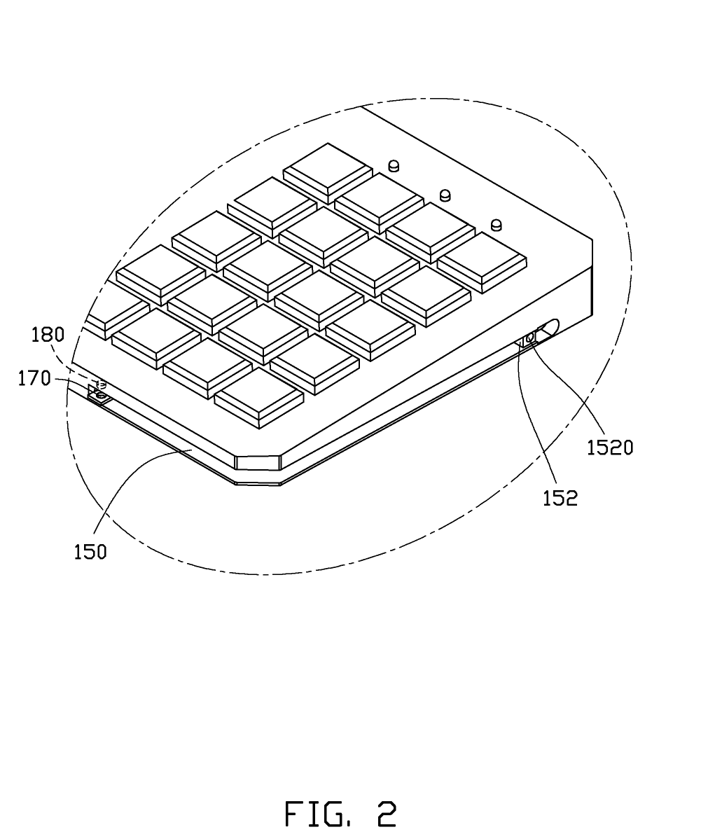

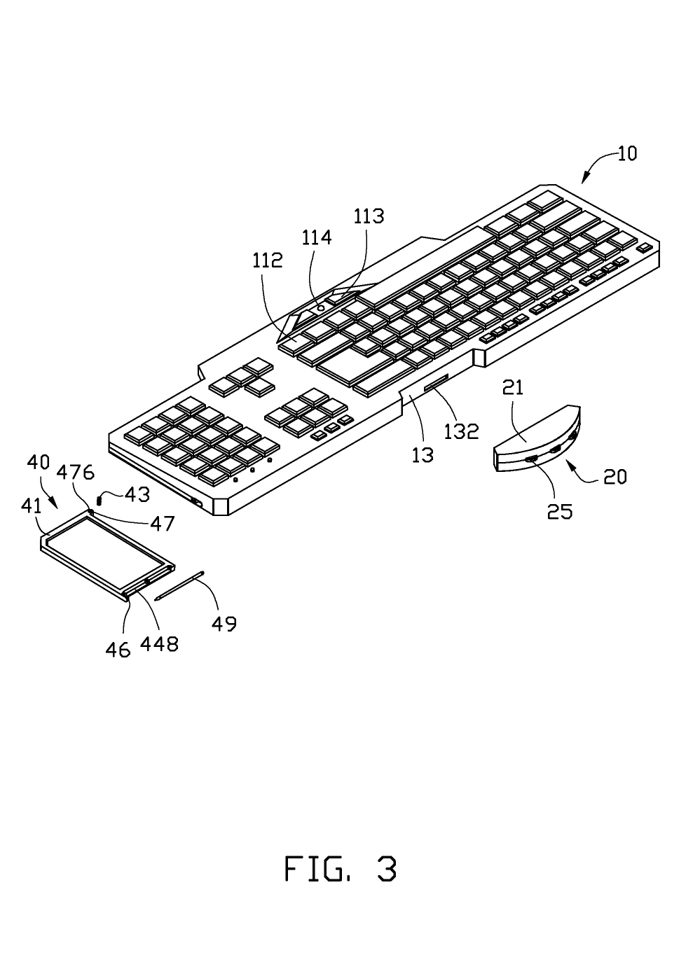

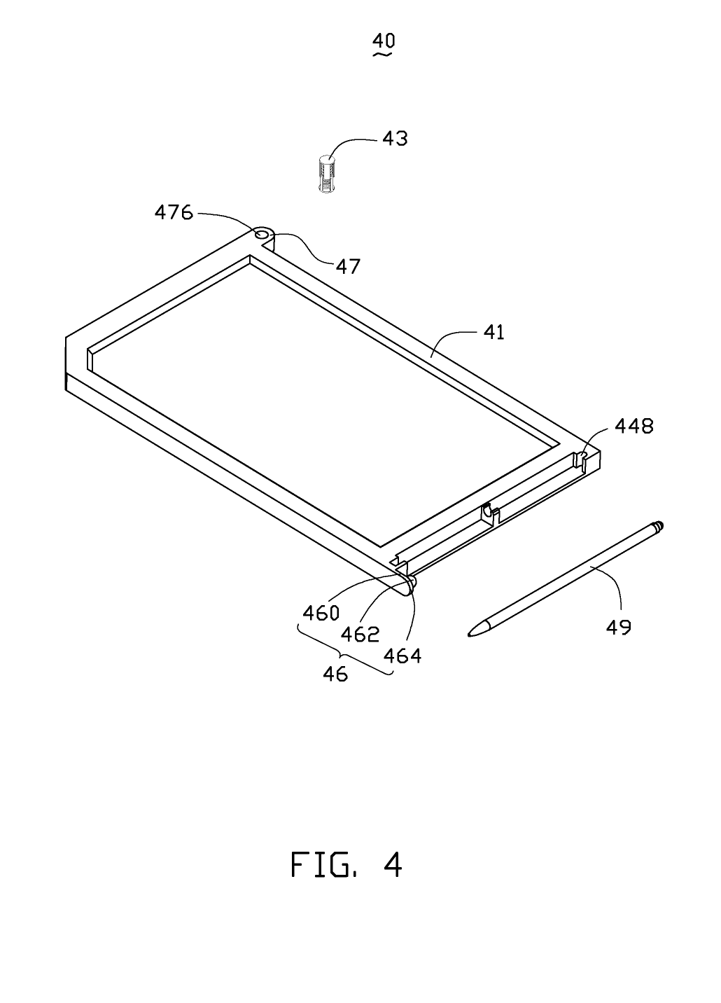

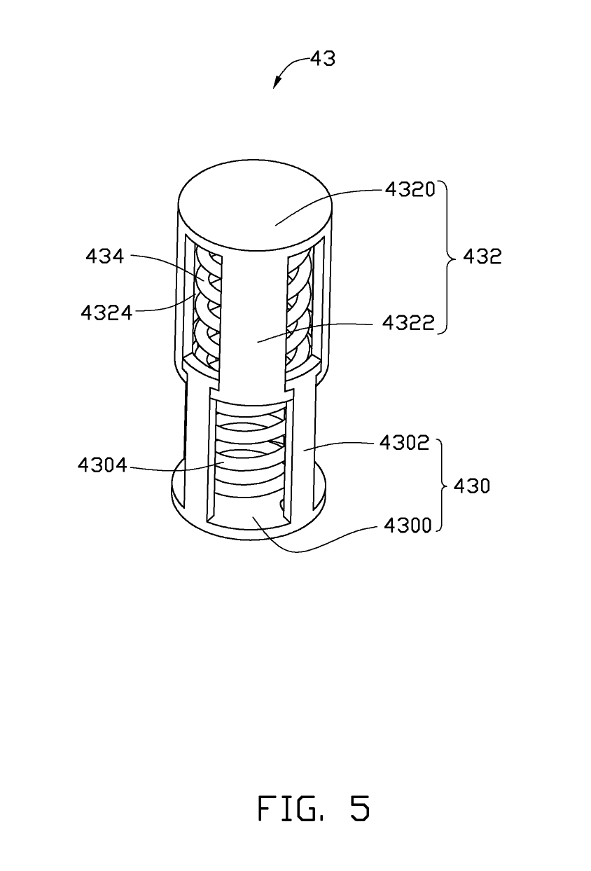

FIGS. 1-5 illustrates an embodiment of a keyboard assembly. The keyboard assembly comprises a main body 10, a receptor 20 connected to the main body 10, and a handwriting pad 40 rotatably attached to the main body 10.

The main body 10 comprises a top panel 11 and a bottom panel 12 substantially parallel to the top panel 11. A plurality of first buttons 112 is located on the top panel 11. Two second buttons 113 and a third button 114 are located on the top panel 11. The plurality of first buttons 112 is used to input words into a computer (not shown). The two second buttons 113 are used to select or affirm whether the handwriting pad 40 is used. The second button 35 is a ball as in a mouse.

A concave portion 13 is defined in the main body 10. An insertion slot 132 is defined in the concave portion 13. A receiving space 150 is defined between the main body 10. In one embodiment, the receiving space 150 is a slot and located between the top panel 11 and the bottom panel 12. A securing portion 152, with a securing hole 1520, is located in the receiving space 150. A first receiving hole 170 is defined in the bottom panel 12, and a second receiving hole 180 is defined in the top panel 11. In one embodiment, the first receiving hole 170 and the second receiving hole 180 are located in the receiving space 150 and aligned in a straight line that is substantially perpendicular to the bottom panel 12.

The receptor 20 comprises a main base 21, an inserting portion 23, and three buttons 25. The three buttons 25 moveably protrude from the receptor 20. The receptor 20 is used to receive signals, such as infrared ray, Bluetooth, and WiFi. The three buttons 25 corresponds to the infrared ray, the Bluetooth, and the WiFi.

The handwriting pad 40 comprises a frame body 41, a fixing member 43 moveably attached to the frame body 41, and a pen 49 secured to the frame body 41. A mounting portion 46 extends from a first corner of the frame body 41. The mounting portion 46 comprises a connecting portion 460, a mounting post 462, and an operating portion 464 connected to the connecting portion 460. The mounting post 462 is located on the connecting portion 460. In one embodiment, the mounting post 462 is substantially perpendicular to the connecting portion 460. A retaining slot 448 is defined in a side of the frame body 41. A protrusion 47, with a through hole 476, is located on a second corner of the frame body 41.

The fixing member 43 comprises a fixing portion 430, a moveable portion 432, and a resilient member 434, located between the fixing portion 430 and the moveable portion 432. The fixing portion 430 comprises a bottom plate 4300 and four first side plates 4302 extending from the bottom plate 4300. In one embodiment, each first side plate 4302 is substantially perpendicular to the bottom plate 4300. A first cutout 4304 is defined between every two adjacent first side plates 4302. The moveable portion 432 comprises a top plate 4320 and four second side plates 4322. The top plate 4320 is substantially parallel to the bottom plate 4300. A second cutout 4324 is defined between every two adjacent second side plates 4322 and corresponds to the first side plate 4302. Each second side plate 4322 corresponds to each first cutout 4304.

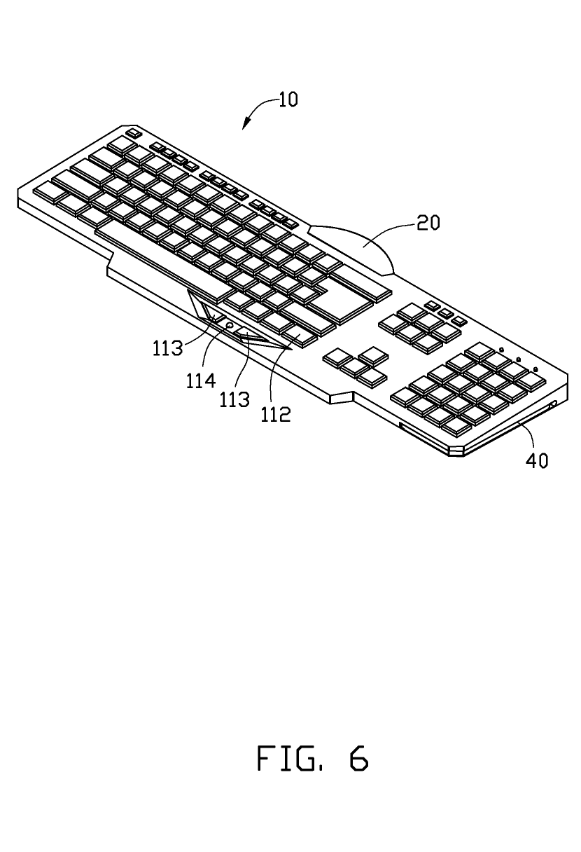

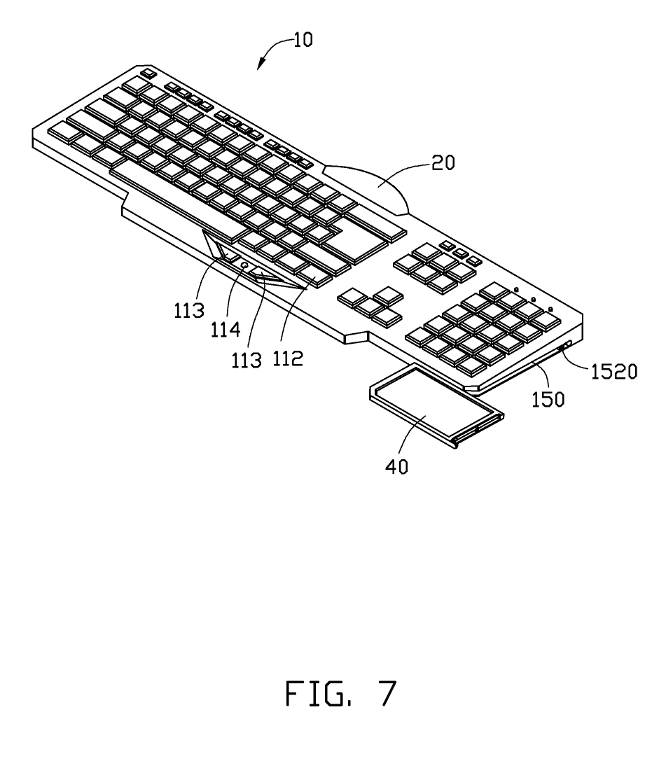

FIGS. 6-7 shows in assembly, the fixing member 43 is received in the through hole 476. The fixing portion 430 and the moveable portion 432 are exposed out of the through hole 476. The top plate 4320 is pressed to deform the resilient member 434, so that the moveable portion 432 is moved towards the fixing portion 430. Each first side plate 4302 is received in corresponding second cutout 4324, and each second side plate 4322 is received in corresponding first cutout 4304. The protrusion 47 of the handwriting pad 40 is inserted into the receiving space 150. The fixing portion 430 is received in the first receiving hole 170. The resilient member 434 is released to move the moveable portion 432 away from the fixing portion 430, thus, the moveable portion 432 can be engaged in the second receiving hole 180 of the top panel 11. The handwriting pad 40 is rotatable about the fixing member 43 towards the receiving space 150, until the mounting post 462 is engaged in the securing hole 1520. Therefore, the handwriting pad 40 is secured in the receiving space 150.

When the handwriting pad 40 is needed, the operating portion 464 is operated to disengage the mounting post 462 from the securing hole 1520. The handwriting pad 40 is rotated about the fixing member 43 and out of the receiving space 150(see FIG. 7).

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A keyboard assembly comprising:
a main body defining a receiving space;
a handwriting pad rotatably received in the receiving space and comprising a frame body and a protrusion located on the frame body; and
a fixing member moveably attached to the protrusion;
wherein the handwriting pad is rotatably secured to the main body by the fixing member, and the handwriting pad is rotatable about the fixing member to remove the handwriting pad from the receiving space.

2. The keyboard assembly of claim 1, wherein the main body comprises a top panel and a bottom panel that is substantially parallel to the bottom panel, the fixing member comprises a fixing portion and a moveable portion, the fixing portion is secured to the bottom panel, and the moveable portion is secured to the top panel.

3. The keyboard assembly of claim 2, wherein the fixing member further comprises a resilient member that is connected to the fixing portion and the moveable portion, and the moveable portion is moveable relative to the fixing portion to deform the resilient member.

4. The keyboard assembly of claim 3, wherein the fixing portion comprises a bottom plate, the moveable portion comprises a top plate, a first end of the resilient member is secured to the bottom plate, and a second end of the resilient member is secured to the top plate.

5. The keyboard assembly of claim 4, wherein the fixing portion further comprises four first side plates connected to the bottom plate, a first cutout is defined every two adjacent first side plates; the moveable portion further comprises four second side plates connected to the top plate, a second cutout is defined every two adjacent second side plate; and each first side plate is received in the second cutout, and each second side plate is received in the first cutout.

6. The keyboard assembly of claim 1, wherein the main body comprises a securing portion, the handwriting pad comprises a mounting portion connected to the frame body, and the mounting portion is engaged with the securing portion.

7. The keyboard assembly of claim 6, wherein the securing portion defines a securing hole, the mounting portion comprises a connecting portion and a mounting post located on the connecting portion, and the mounting post is engaged in the securing hole.

8. The keyboard assembly of claim 1, further comprising a receptor, wherein a concave portion is defined in the main body, the concave portion defines an inserting slot, and the receptor comprises an inserting portion engaged in the inserting slot.

9. A keyboard assembly comprising:
a main body comprising a top panel and a bottom panel; a receiving space is defined in the main body;
a handwriting pad rotatably received in the receiving space; and
a fixing member moveably attached to the handwriting pad; the fixing member comprising a fixing portion and a moveable portion; the fixing portion is secured to the bottom panel, and the moveable portion is secured to the top panel;
wherein the handwriting pad is rotatably secured to the main body by the fixing member, and the handwriting pad is rotatable about the fixing member to remove the handwriting pad from the receiving space.

10. The keyboard assembly of claim 9, wherein the bottom panel defines a first receiving hole, the top panel defines a second receiving hole; the fixing portion is received in the first receiving hole, and the moveable portion is received in the second receiving hole.

11. The keyboard assembly of claim 9, wherein the fixing member further comprises a resilient member connected to the fixing portion and the moveable portion, and the moveable portion is moveable relative to the fixing portion to deform the resilient member.

12. The keyboard assembly of claim 11, wherein the fixing portion comprises a bottom plate, the moveable portion comprises a top plate, a first end of the resilient member is secured to the bottom plate, and a second end of the resilient member is secured to the top plate.

13. The keyboard assembly of claim 12, wherein the fixing portion further comprises four first side plates connected to the bottom plate, a first cutout is defined every two adjacent first side plates; the moveable portion further comprises four second side plates connected to the top plate, a second cutout is defined every two adjacent second side plate; each first side plate is received in the second cutout, and each second side plate is received in the first cutout.

14. The keyboard assembly of claim 9, wherein the main body comprises a securing portion, the handwriting pad comprises a frame body and a mounting portion connected to the frame body, and the mounting portion is engaged with the securing portion.

15. The keyboard assembly of claim 14, wherein the securing portion defines a securing hole, the mounting portion comprises a connecting portion and a mounting post located on the connecting portion, and the mounting post is engaged in the securing hole.

16. The keyboard assembly of claim 9, further comprising a receptor, wherein a concave portion is defined in the main body, the concave portion defines an inserting slot, and the receptor comprises an inserting portion engaged in the inserting slot.
